(19) United States
(12) Patent Application Publication
(10) Pub. No.: US 2011/0296059 A1
(43) Pub. Date: Dec. 1, 2011

(54) System and method for seamless management of multi-personality mobile devices

(75) Inventor: David P. Sperling, Laguna Niguel, CA (US)

(73) Assignee: SMITH MICRO SOFTWARE, INC., ALISO VIEJO, CA (US)

(21) Appl. No.: 13/136,461

(22) Filed: Aug. 1, 2011

Related U.S. Application Data
(63) Continuation of application No. 12/260,770, filed on Oct. 29, 2008.
(60) Provisional application No. 60/983,513, filed on Oct. 29, 2007.

(51) Int. Cl. G06F 3/00

(52) U.S. Cl. 710/14

(57) ABSTRACT

A system and method for managing multi-mode mobile devices from a personal computer (PC) in which the two devices are communicating over a point to point connection such as a Universal Serial Bus (USB) or TCP/IP and provides a mechanism to remotely control the personality of the device over the communications link. Furthermore, the system and method allows the user of the PC to control when the personality change occurs and also allows specific system events to control personality changes automatically on the user's behalf. Additionally, the system and method controls the user experience on both the mobile device and PC to ensure that the appropriate application is available to accept a connection to the new personality on both the mobile device and the PC.

### CROSS REFERENCES TO RELATED APPLICATIONS

The present application is a continuation of U.S. Utility patent application Ser. No. 12/260,770 filed Oct. 28, 2009 (Oct. 28, 2009,) now pending.

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to methods for controlling mobile devices, such as mobile telephones, from another computing device, such as another mobile device or a personal computer (PC). More particularly the present invention relates to a system and method for controlling the personality of a multi-mode mobile device remotely over a communications link. Still more specifically, the present invention is a method for switching the personality of a device either under user control or automatically based on specific system events on either the mobile device or the PC.

2. Discussion of Related Art including information disclosed under 37 CFR §§1.97, 1.98

Even as the computing power of mobile devices continues to increase, consumers regularly outpace the improvements with their own demands for their devices. They want them to do more while they carry fewer of them on their person.

Until quite recently, many mobile devices were task-specific standalone products that did not communicate with companion devices. Examples include mobile telephones, home telephones, Internet access terminals, digital cameras, music players, GPS devices, mapping devices, handheld calculators, personal information devices, file storage devices, personal health monitors (such as glucose testers and blood pressure devices), to name only a fraction of such devices. Manufacturers of these devices must now keep pace with the market trend to integrate more and more functionality into a single device.

As the complexity of a mobile devices has increased with added functionality, there has been a corresponding increase in the complexity of the communication link between the mobile device and a companion computing devices such as another mobile device, PC, or server. The communications link (“ComLink”), usually a Universal Serial Bus (USB) connection, a local or Internet routed TCP/IP network, or a personal area network (such as IrDA or Bluetooth), connects the mobile device to the PC. Generally most ComLinks are able to carry data between devices in which certain data is tagged for delivery to a certain end-point of a device that allows for multiple simultaneous communication channels (“channels”). Even though the ComLink is capable of multiple channels, the software running on each end of the link must be able to interpret the data on the channel and perform appropriate steps to send the data (the “sender”) and process the data (the “receiver”). In many cases, mobile devices have limited resources, such as Random Access Memory (“RAM”), and cannot hold and control multiple receivers or senders simultaneously. In other cases two mobile device receivers or senders may be incompatible with one another such that they are unable to run at the same time. In order for the device to support its multiple personalities, a method is required to swap in the appropriate sender and receiver software on the device at the appropriate time.

One solution to this problem is to provide a multi-mode device with a user selectable control that changes the mode of the device (“mode switch”). As the user changes the switch from one setting to another (for example from a digital camera to a wireless modem), the “personality” of the device changes as the appropriate senders and receives are loaded into the device RAM. After the switch, the appropriate software can then be run on the PC to communicate with the mobile device (in this case a photo download tool or modem dialer application).

However, there remains a need for a method to switch the personality of a device either under user intervention or automatically if certain system events on either the mobile device or the PC called for such a switch.

### BRIEF SUMMARY OF THE INVENTION

The present invention solves the foregoing problem by providing a system and method of controlling the user experience on both a mobile device and a PC, where through either user input from the mobile device or PC, or through automated methods, the appropriate software applications are loaded on both the mobile device and the PC to carry out a specific user task. The invention accomplishes this through the use of a multipurpose listener installed on the PC. The listener is programmed for all elements of the set of personalities possessed by a device. When the user changes the position of the switch on the device, the PC listener detects the change, typically by a command sent from the mobile device, or if the solution is based on USB, a new USB endpoint is detected on the USB bus and is then detected by the PC listener. The listener will then run the appropriate PC application to deal with the device.

Accordingly, the present invention provides seamless management of a multi-mode device system that allows a remote PC to control the state of the multi-mode device. A user controlled mode switch is no longer needed, although if so provided, the switch can interoperate with the inventive system as well. The novel system includes a listener software application that must be present or installed and running on the mobile device.

The listener can take multiple forms including a filter listener, interceptor listener, and target listener. Filter listeners can be installed to inspect all traffic flowing to targeted listeners in the system and can wait for specific commands to be sent by the PC. Filter listeners do not modify any of the traffic traveling over the ComLink. Interceptor listeners are similar to filter listeners except that they do not pass all ComLink traffic on to other listeners and specifically consume the traffic that is used to trigger personality switching. Target listeners open up a new channel used specifically for the purpose of controlling the personality of the device. All ComLink traffic directed to the target listener is consumed and not passed on to other listeners. Each of the three specific mobile based listeners may be referred to as a “mobile controller.”

Additionally, in the present invention the PC contains a “commander,” which is a custom sender module that communicates with the mobile controller. The commander both accepts requests from the user and listens for system events on the PC. The commander contains a customizable decision matrix built specifically to map the capabilities of the device into a set of decision points that are followed by the commander.

This system and method improves on prior art by placing the control of the multi-mode device within the remote PC. (The multi-mode device may be variously referred to herein as “multi-mode device”, and/or “mobile device” and/or “mobile multi-mode device”, and may itself comprise a personal computer). This is advantageous for operations where the user will be using the screen and input devices from the PC to perform a user task. For practical reasons, in many cases it is simply not convenient to control an operation from a mobile device. This is because the display screen is typically much smaller and more difficult for a user to read, the data input elements are smaller or have limited functionality and therefore more difficult to use than those on a PC, or the mobile device is not convenient for the user to reach. This last case might occur when the ComLink between the PC and mobile device is wireless, and the mobile device is stored away from ready access in a pocket or purse.

The system and method, when applied to a mobile device and PC, employs the following method steps:

The user connects a mobile device having a plurality of operating modes with a PC through a ComLink. The mobile controller knows or discovers (a) which mode the mobile device is currently running (such as camera mode, disk mode, modem mode, health monitor mode, GPS mode); (b) which modes are compatible and can be run simultaneously and which modes are incompatible with others; and (c) which applications are currently running on the mobile device.

A commander running on a PC is aware of a set of mobile devices with which it is compatible. The commander is aware of the connected state of one or more mobile devices and (a) knows or discovers the mobile device mode list, (b) the mobile application list in communication with the mobile controller, and (c) the compatible applications available on the local PC. It detects from AppSpace when a compatible application is running on the PC and sends a command over the ComLink to the mobile controller to change the mode of the multi-mode device and to run the appropriate application to serve the user's request.

When the commander detects that a mobile multi-mode device has arrived (i.e., is currently connected via the ComLink) the commander can send a command to the mobile controller to change the mode of the multi-mode device. The mode change can be made according to several heuristics or user preferences, such as returning the mobile multi-mode device to the last mode used by the PC, to switch the mode to the user's favorite mode, or to switch a mode according to the set of applications currently running on either the mobile multi-mode device or the PC. The way the commander changes the mode of the device is novel, unrelated to the way in which a mode switch would be done manually from the mobile device from either a software or hardware mode switch, and achieves far better results.

It is therefore an object of the present invention to provide a new and improved system and method to change the mode of a multi-personality device to best suit the user's need and to eliminate steps the user would have to perform with prior art systems.

It is another object of the present invention to provide a new and improved method of controlling a multi-mode device wherein when the PC and mobile device are already connected via a ComLink, the commander detects when the user runs or launches an application on the PC that is compatible with a mode of the mobile device, for example, a digital photo transfer tool. In this instance, the commander sends a command to the mobile controller to have it configure the device so that is correctly set up (both mobile applications and the mode of the device) so that it can correctly communicate in photo mode. This allows the user to have a seamless experience with the local photo application in transferring photos to and from a mobile device over the ComLink.

It is another object of the present invention to provide a new and improved method of allowing the user to change the mode of a mobile device through a UI mechanism of a PC that then relays the request to the commander. The commander sends the mode switch to the mobile controller and then both the mobile controller and the commander can ensure that appropriate mode changes occur and that the correct software applications are loaded to AppSpace. This simulates a hardware or software switch on the device without the user having to use the mode switch on the device itself.

Yet another principal object of the system is to provide a method to change the mode of a multi-personality device that is compatible with both hardware and software mode switches. According to the present invention, if the user presses a mobile-based mode switch, the mobile controller detects this case and communicates the user mode change to the commander. The mobile commander can then take action on the PC on the user's behalf. For example, if the user pressed a soft switch to turn the mobile device into a wireless modem, the commander would be alerted and run a Internet connection client on the PC to connect to the Internet through the ComLink to the mobile device.

Another object of the present invention is to provide a method to improve the overall user experience by control when applications are run on both the mobile device and the PC. Certain applications that communicate with another piece of software may make assumptions that the software running on the other side of the ComLink must be running first. If this does not occur, the software may experience timeouts or errors while it unsuccessfully waits for the other application to appear. Thus, in the present invention, the commander or mobile controller can operate in a mode in which they are aware of these application dependencies and are then able to sequence commands to avoid timeouts and errors in applications that require a ComLink.

Another object of the present invention is to provide a method to improve the manner in which ComLink problems are detected, correctly identified, and corrected. The mobile controller and the commander communicate directly. However, if they are unable to communicate, they know when the user is attempting a ComLink connection and can run troubleshooting sequences and repair problems, such as re-installing software drivers on the mobile device or PC, to restore a functional ComLink.

Yet another object of the present invention is to provide a method of controlling the mode of the mobile device by allowing the commander to take several forms. This is accomplished by having the commander run outside any other application. This allows it to detect and control the mobile device with no other applications running on the PC. The commander can be adapted to run as a component inside of a host application and thus can control the mobile device during the lifetime of the host application. This may be the case if the mobile device has a limited number of modes, or if it is necessary to control the device only during certain times (while the Host application is running).

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic flow diagram illustrating the general functional elements of the present invention.

FIG. 2 is a schematic flow diagram showing specific components of the mobile device;

FIG. 3 is a schematic flow diagram showing specific components of the personal computer (PC);

FIG. 4 is a schematic diagram showing details of the ComLink interface running on the mobile device or the ComLink Interface running on the PC; and

FIG. 5 is a schematic flow diagram showing how a mobile device and PC communicate when connected via a ComLink.

### DRAWING REFERENCE NUMERALS

10 mobile device
11 personal computer
12 Internet
13 personal area network
14 USB
15 Bluetooth
16 Bluetooth
17 mobile network operator (MNO)
18a cable modem
18b wireless Internet connection
20 mobile controller
21 application space
22 user interface (UI)
23 user input device
24 Comlink interface
25 hardware mode switch
26 software switch
28 multiple applications
29 software switch
30 commander
31 AppSpace
32 user interface
33 user input
34 Comlink interface
38 multiple applications
39 multiple applications
40 software interface element
41 software interface TCP/IP
42 software interface
43 hardware element
44 Ethernet hardware
45 PAN hardware

### DETAILED DESCRIPTION OF THE INVENTION

### Definitions

As used herein, the term “AppSpace” means a portion of a computing device (mobile device or PC) which runs either operating system (OS) processes or applications as well as processes and applications on behalf of the user. The host OS is generally responsible for starting, stopping, and managing these processes and applications.

Additionally, as used herein “Application” means a software program running within AppSpace that provides either the OS or the user with specific functionality.

The term “ComLink” is used for any wired or wireless communications medium between computing devices such as TCP/IP, Bluetooth, Universal Serial Bus, and Wireless Wide Area Network protocols such as GSM/EDGE/UMTS/HSPA or CDMA/1xRTT/EVDO.

The term mobile network operator (MNO), may also be referred to as a carriage service provider (CSP), wireless service provider, wireless carrier, mobile phone operator, or cellular company, and denotes a telephone company providing mobile phone service subscribers.

The term personal computer (PC) refers to a desktop computer, a laptop computer or a tablet computer.

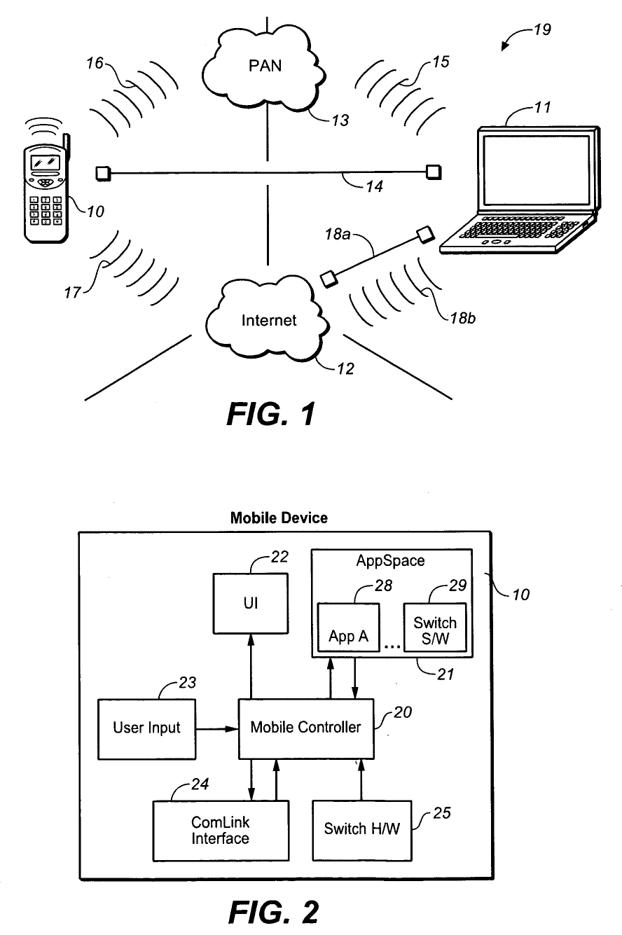

Referring to FIGS. 1 through 5, there is illustrated a new and improved system and method for controlling a multi-personality mobile device.

FIG. 1 is a schematic flow diagram illustrating the general functional elements of the present invention. Within the context of the user's personal space 19, there is a mobile device 10 that connects to a personal computer (PC) 11 over a communications link (ComLink). The

ComLink can take one of several suitable forms, including a cable link over serial or USB 14, over a personal area network 13 such as an UMA, 802.11 or Bluetooth 15, 16 or over the Internet 12. For Internet connectivity, the mobile device is connected via a mobile network operator (MNO) 17 and the PC is connected to the Internet through a cable such as Ethernet, DSL, cable modem 18a or a wireless Internet connection using 802.11, GSM/EDGE/UMTS/HSPA or CDMA/1xRTT/EVDO 18b.

FIG. 2 is a schematic flow diagram showing specific components of the mobile device 10. The mobile device has a ComLink interface 24 which connects the device to the outside world, a hardware mode switch 25 which allows the user to physically control the mode of the device with a hardware button on the device, a user input device 23 such as a keypad or touch screen, a user interface (UI) 22 such as an LCD screen, an application space 21 in which multiple applications 28 can run to perform various functions for the user. Various applications run inside the AppSpace including a software switch 29 which is a software equivalent of the hardware switch (a way to change the mode of the device). The mobile controller 20 is the component that connects the various components to make decisions based on input from the components (ComLink, hardware switch, user input, and AppSpace) and produce various results such as sending commands over the ComLink, displaying UI or communicating with the AppSpace. The mobile controller can run as part of the overall operating system on the mobile device 10 or as an application with the AppSpace.

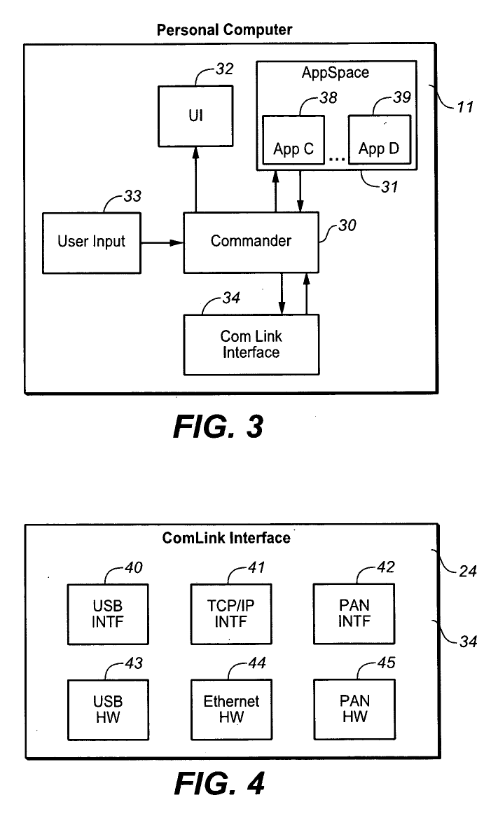

FIG. 3 is a schematic flow diagram showing specific components of the personal computer (PC) 11. The PC has a ComLink interface 34 witch connect the PC to the outside world, a user input device 33 such as a keyboard, mouse or touchpad, a user interface (UI) 32 such as an LCD or CRT screen, an application space 21 in which multiple applications 38, 39 can run to perform various functions for the user. The commander 30 is the component that connects the various components to make decisions based on input from the various components (ComLink, User Input and AppSpace) and produce various results, such as sending commands over the ComLink, displaying UI, or communicating with the AppSpace. The mobile controller can run as part of the overall operating system on the PC 11 or as an application with the AppSpace.

FIG. 4 is a schematic diagram shows the detail of the ComLink Interface 24 running on the mobile device 10 or the ComLink interface 34 running on the PC 11. Both devices can have various connection methods to the outside world including wired connections (USB and serial), Internet connections and personal area network connections. USB or other wired connections have a hardware element 43 and a software interface element 40 which connects the hardware into the operating system of the mobile device or PC. Similar hardware and interfaces exist for Ethernet hardware 44 and its' software interface TCP/IP 41 and PAN hardware 45 and its software interface 42. Since many of the methods herein operate over one or all of these communications link, we will refer to these technologies generically herein as a “ComLink”.

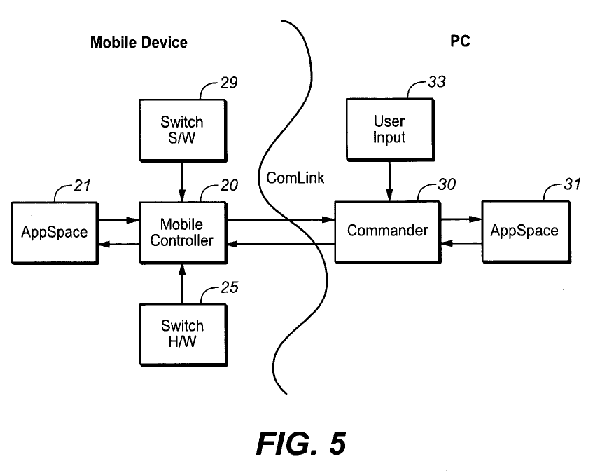

FIG. 5 is a schematic flow diagram that shows how a mobile device and PC commutate when connection via a ComLink. The mobile controller take input from the software switch 29, the hardware switch 25, the commander 30 as well as accept input from the AppSpace 21. An example of this input from the AppSpace is the detection of when specific applications are started or loaded within the mobile device. The mobile controller can send output to both the AppSpace as well as the commander 30 over the ComLink. Likewise on the PC, it can accept input from the user 33 and the AppSpace 31 as well as send output to the AppSpace and ComLink. The commander takes input from the mobile controller 20, user input 33 and AppSpace 31 and sends output to the mobile controller 20 as well as AppSpace 31.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A system and method of managing a multi-mode computing device using a remote controlling device, comprising the steps of:
(a) connecting the multi-mode computing device to a communications network;
(b) connecting the controlling device to the communications network;
(c) establishing a data communications connection between the multi-mode computing device and the controlling device using the communications network;
(d) detecting the controlling device with the multi-mode computing device through the communications network;
(e) sending the current mode of the multi-mode computing device from the multi-mode computing device to the controlling device over the communications network, the message including at least a user selected mode;
(f) receiving a message at the multi-mode computing device from the controlling device via the data communications connection; and
(g) switching the multi-mode computing device to the selected mode.

2. The method of claim 1, further including the step of retrieving from the multi-mode computing device with the controlling device a set of possible modes of the multi-mode computing device and selecting a mode of the multi-mode computing device only if it is included in the set of possible modes.

3. The method of claim 2, further including the steps of:
displaying a list of the compatible modes of the multi-mode computing device to the user of the remote controlling device;
selecting one mode from the list of compatible modes using the controlling device;
sending a message to the multi-mode computing device, wherein the message contains at least information specifying the mode to which the multi-mode computing device must switch; and
switching the multi-mode computing device to the specified mode.

4. The method of claim 1, further including the step of loading an application on the controlling device that is compatible with the user selected mode.

5. The method of claim 1, further including the step of running an application on the multi-mode computing device only if it matches the capabilities of the user selected mode.

6. The method of claim 1, further including the step of:
detecting mode changes of the multi-mode device with the controlling device; and
changing the mode of the multi-mode computing device without any intervention of the controlling device.

7. The method of claim 1, further including the steps of:
detecting applications running on the controlling device with the multi-mode computing device; and
changing the mode of the multi-mode computing device to a mode compatible with the detected application when the detected application is compatible with a mode on the multi-mode device.
